(19) United States
(12) Patent Application Publication
(10) Pub. No.: US 2015/0120899 A1
(43) Pub. Date: Apr. 30, 2015

(54) DATA MANAGEMENT SYSTEM

(71) Applicant: Ostrato Inc., Sterling, VA (US)

(72) Inventors: Michael C. Biddick, Vienna, VA (US); Ray John Chapel, III, Ashburn, VA (US)

(21) Appl. No.: 14/523,261

(22) Filed: Oct. 24, 2014

Related U.S. Application Data
(60) Provisional application No. 61/895,127, filed on Oct. 24, 2013.

(51) Int. Cl. H04L 29/08; H04L 12/911

(52) U.S. Cl. CPC H04L 67/10; H04L 47/82
USPC 709/223

(57) ABSTRACT

A method, computer program product, and computing system for obtaining a first set of descriptors from a first cloud service provider. The first set of descriptors defines one or more resources available from the first cloud service provider. At least a second set of descriptors is obtained from at least a second cloud service provider. The at least a second set of descriptors defines one or more resources available from the at least a second cloud service provider. The at least one of the first set of descriptors and the at least a second set of descriptors are processed to generate a homogenized set of descriptors. The homogenized set of descriptors describes the one or more resources available from the first cloud service provider and the one or more resources available from the at least a second cloud service provider in a uniform fashion.

### RELATED APPLICATION

This application claims the benefit of U.S. Provisional Patent Application No. 61/895,127, filed on 24 Oct. 2013, entitled “Cloud Management System”, the entire contents of which are herein incorporated by reference.

### TECHNICAL FIELD

This disclosure relates to cloud-based service providers and, more particularly, to systems that allow for the management of cloud-based service providers.

### BACKGROUND

With the unprecedented expansion of the internet and the services provided thereon, a variety of service providers that emerged that provide “cloud-based” resources. Unfortunately, each of these service providers has their own nomenclature concerning the individual cloud resources available/provided. For example, Amazon Web Services may define the state of a compute instance using one word, while Microsoft Azure may define the same exact state of a compute instance using another word. Complicating matters further is the fact that the underlying intention and meaning behind each of these words may be effectively the same. Further, one service provider may define the word “status” as having a first definition in the context of their environment, while another service provider may define the same word “status” as having a second (and totally different) definition in the context of their environment.

Accordingly and for an end-user that utilizes cloud resources provided by multiple service providers, keeping track of such disparate nomenclatures is typically not practical and may present an inefficient means of managing their cloud-based resources.

### SUMMARY OF DISCLOSURE

In one implementation, a computer-implement method includes obtaining a first set of descriptors from a first cloud service provider. The first set of descriptors defines one or more resources available from the first cloud service provider. At least a second set of descriptors is obtained from at least a second cloud service provider. The at least a second set of descriptors defines one or more resources available from the at least a second cloud service provider. The at least one of the first set of descriptors and the at least a second set of descriptors are processed to generate a homogenized set of descriptors. The homogenized set of descriptors describes the one or more resources available from the first cloud service provider and the one or more resources available from the at least a second cloud service provider in a uniform fashion.

One or more of the following features may be included. The homogenized set of descriptors may be displayed to a user of a remote computing device. The first set of descriptors may include a first set of metadata. The at least a second set of descriptors may include at least a second set of metadata. Obtaining the first set of descriptors from the first cloud service provider may include obtaining the first set of descriptors via an API accessible on a remote server controlled by the first cloud service provider. Obtaining at least a second set of descriptors from at least a second cloud service provider may include obtaining the at least a second set of descriptors via an API accessible on a remote server controlled by the at least a second cloud service provider. Processing at least one of the first set of descriptors and the at least a second set of descriptors to generate a homogenized set of descriptors may include generating the homogenized set of descriptors by processing the first set of descriptors to be compatible with the at least a second set of descriptors. Processing at least one of the first set of descriptors and the at least a second set of descriptors to generate a homogenized set of descriptors may include generating the homogenized set of descriptors by processing the at least a second set of descriptors to be compatible with the first set of descriptors. Processing at least one of the first set of descriptors and the at least a second set of descriptors to generate a homogenized set of descriptors may include generating the homogenized set of descriptors by processing the first set of descriptors and the at least a second set of descriptors.

In another implementation, a computer program product resides on a computer readable medium that has a plurality of instructions stored on it. When executed by a processor, the instructions cause the processor to perform operations including obtaining a first set of descriptors from a first cloud service provider. The first set of descriptors defines one or more resources available from the first cloud service provider. At least a second set of descriptors is obtained from at least a second cloud service provider. The at least a second set of descriptors defines one or more resources available from the at least a second cloud service provider. The at least one of the first set of descriptors and the at least a second set of descriptors are processed to generate a homogenized set of descriptors. The homogenized set of descriptors describes the one or more resources available from the first cloud service provider and the one or more resources available from the at least a second cloud service provider in a uniform fashion.

One or more of the following features may be included. The homogenized set of descriptors may be displayed to a user of a remote computing device. The first set of descriptors may include a first set of metadata. The at least a second set of descriptors may include at least a second set of metadata. Obtaining the first set of descriptors from the first cloud service provider may include obtaining the first set of descriptors via an API accessible on a remote server controlled by the first cloud service provider. Obtaining at least a second set of descriptors from at least a second cloud service provider may include obtaining the at least a second set of descriptors via an API accessible on a remote server controlled by the at least a second cloud service provider. Processing at least one of the first set of descriptors and the at least a second set of descriptors to generate a homogenized set of descriptors may include generating the homogenized set of descriptors by processing the first set of descriptors to be compatible with the at least a second set of descriptors. Processing at least one of the first set of descriptors and the at least a second set of descriptors to generate a homogenized set of descriptors may include generating the homogenized set of descriptors by processing the at least a second set of descriptors to be compatible with the first set of descriptors. Processing at least one of the first set of descriptors and the at least a second set of descriptors to generate a homogenized set of descriptors may include generating the homogenized set of descriptors by processing the first set of descriptors and the at least a second set of descriptors.

In another implementation, a computing system includes at least one processor and at least one memory architecture coupled with the at least one processor, wherein the computing system is configured to perform operations including obtaining a first set of descriptors from a first cloud service provider. The first set of descriptors defines one or more resources available from the first cloud service provider. At least a second set of descriptors is obtained from at least a second cloud service provider. The at least a second set of descriptors defines one or more resources available from the at least a second cloud service provider. The at least one of the first set of descriptors and the at least a second set of descriptors are processed to generate a homogenized set of descriptors. The homogenized set of descriptors describes the one or more resources available from the first cloud service provider and the one or more resources available from the at least a second cloud service provider in a uniform fashion.

One or more of the following features may be included. The homogenized set of descriptors may be displayed to a user of a remote computing device. The first set of descriptors may include a first set of metadata. The at least a second set of descriptors may include at least a second set of metadata. Obtaining the first set of descriptors from the first cloud service provider may include obtaining the first set of descriptors via an API accessible on a remote server controlled by the first cloud service provider. Obtaining at least a second set of descriptors from at least a second cloud service provider may include obtaining the at least a second set of descriptors via an API accessible on a remote server controlled by the at least a second cloud service provider. Processing at least one of the first set of descriptors and the at least a second set of descriptors to generate a homogenized set of descriptors may include generating the homogenized set of descriptors by processing the first set of descriptors to be compatible with the at least a second set of descriptors. Processing at least one of the first set of descriptors and the at least a second set of descriptors to generate a homogenized set of descriptors may include generating the homogenized set of descriptors by processing the at least a second set of descriptors to be compatible with the first set of descriptors. Processing at least one of the first set of descriptors and the at least a second set of descriptors to generate a homogenized set of descriptors may include generating the homogenized set of descriptors by processing the first set of descriptors and the at least a second set of descriptors.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a data management process according to an implementation of the present disclosure; and

FIG. 2 is a flowchart of the data management process of FIG. 1 according to an implementation of the present disclosure.

Like reference symbols in the various drawings indicate like elements.

### DETAILED DESCRIPTION OF THE PREFERRED EMBODIMENTS

### System Overview:

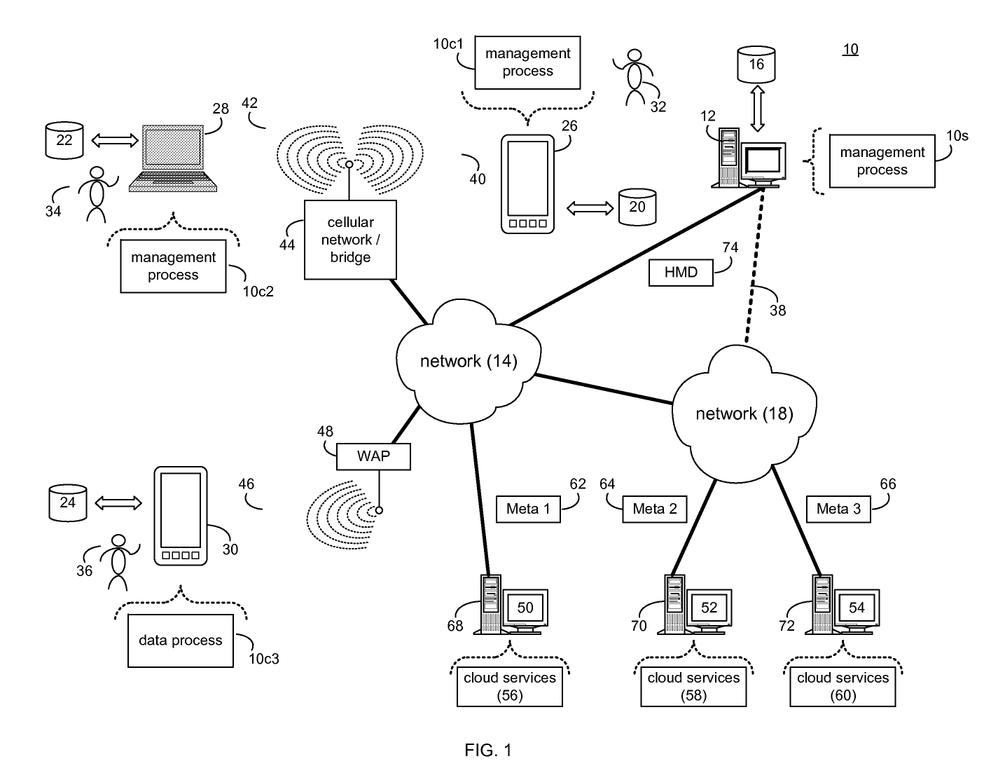

Referring to FIG. 1, there is shown data management process 10. As will be discussed below in greater detail, data management process 10 may be utilized to manage multiple cloud service providers.

Data management process 10 may be implemented as a server-side process, a client-side process, or a hybrid server-side/client-side process. For example, data management process 10 may be implemented as a purely server-side process via data management process 10s. Alternatively, data management process 10 may be implemented as a purely client-side process via one or more of client-side process 10c1, client-side process 10c2 and client-side process 10c3. Alternatively still, data management process 10 may be implemented as a hybrid server-side/client-side process via data management process 10s in combination with one or more of client-side process 10c1, client-side process 10c2 and client-side process 10c3. Accordingly, data management process 10 as used in this disclosure may include any combination of data management process 10s, client-side process 10c1, client-side process 10c2 and client-side process 10c3.

Data management process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

The instruction sets and subroutines of data management process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side processes 10c1, 10c2, 10c3 may include but are not limited to a web browser, a game console user interface, or a specialized application (e.g., an application running on e.g., the Android™ platform or the iPhone™ platform). The instruction sets and subroutines of client-side applications 10c1, 10c2, 10c3, which may be stored on storage devices 20, 22, 24 (respectively) coupled to client electronic devices 26, 28, 30 (respectively), may be executed by one or more processors (not shown) and one or more memory architectures (not shown) incorporated into client electronic devices 26, 28, 30 (respectively). Examples of storage devices 20, 22, 24 may include but are not limited to: hard disk drives; tape drives; optical drives; RAID devices; random access memories (RAM); read-only memories (ROM), and all forms of flash memory storage devices.

Examples of client electronic devices 26, 28, 30 may include, but are not limited to, data-enabled, cellular telephone 26, laptop computer 28, personal digital assistant 30, a personal computer (not shown), a notebook computer (not shown), a server computer (not shown), a gaming console (not shown), a smart television (not shown), and a dedicated network device (not shown). Client electronic devices 26, 28, 30 may each execute an operating system, examples of which may include but are not limited to Microsoft Windows™, Android™, WebOS™, iOS™, Redhat Linux™, or a custom operating system.

Users 32, 34, 36 may access data management process 10 directly through network 14 or through secondary network 18. Further, data management process 10 may be connected to network 14 through secondary network 18, as illustrated with link line 38.

The various client electronic devices (e.g., client electronic devices 26, 28, 30) may be directly or indirectly coupled to network 14 (or network 18). For example, data-enabled, cellular telephone 26 and laptop computer 28 are shown wirelessly coupled to network 14 via wireless communication channels 40, 42 (respectively) established between data-enabled, cellular telephone 26, laptop computer 28 (respectively) and cellular network/bridge 44, which is shown directly coupled to network 14. Further, personal digital assistant 30 is shown wirelessly coupled to network 14 via wireless communication channel 46 established between personal digital assistant 32 and wireless access point (i.e., WAP) 48, which is shown directly coupled to network 14. Additionally, one or more others devices (e.g., personal computers and server computers; not shown) may be directly coupled to network 18 via a hardwired network connection.

WAP 48 may be, for example, an IEEE 802.11a, 802.11b, 802.11g, 802.11n, Wi-Fi, and/or Bluetooth device that is capable of establishing wireless communication channel 46 between personal digital assistant 30 and WAP 48. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

As discussed above, one or more cloud service providers (e.g., cloud service providers 50, 52, 54) may be configured to provide an assortment of cloud resources (e.g., cloud resources 56, 58, 60). Examples of these cloud resources (e.g., cloud resources 56, 58, 60) may include but are not limited to could-based data storage services and cloud-based data processing services.

Any of client electronic devices 26, 28, 30 may utilize the above-described cloud resources (e.g., cloud resources 56, 58, 60) of cloud service providers (e.g., cloud service providers 50, 52, 54). As discussed above, data management process 10 may be configured to manage multiple cloud service providers (e.g., cloud service providers 50, 52, 54). Further and as discussed above, each of these cloud service providers (e.g., cloud service providers 50, 52, 54) may have their own nomenclature concerning the individual cloud resources (e.g., cloud resources 56, 58, 60) available/provided. The nomenclature associated with each of these cloud resources (e.g., cloud resources 56, 58, 60) may be defined via metadata. For example, metadata 62 may define cloud resources 56 offered by cloud service providers 50. Further, metadata 64 may define cloud resources 58 offered by cloud service providers 52. Additionally, metadata 66 may define cloud resources 60 offered by cloud service providers 54.

The instruction sets and subroutines of cloud resources 56, 58, 60 may be executed by one or more processors (not shown) and one or more memory architectures (not shown) included within server computers 68, 70, 72 (respectively). Metadata 62, 64, 66 may be stored on storage devices (not shown) coupled to server computers 68, 70, 72. Examples of these storage devices (not shown) may include but are not limited to: a hard disk drive; a tape drive; an optical drive; a RAID device; a random access memory (RAM); a read-only memory (ROM); and all forms of flash memory storage devices.

### Data Management Process:

Assume for illustrative purposes that user 34 may be interested in obtaining one or more cloud resources (e.g., cloud resources 56, 58, 60) that are offered by one or more cloud service providers (e.g., cloud service providers 50, 52, 54). As discussed above, each of these cloud service providers (e.g., cloud service providers 50, 52, 54) may have their own nomenclature concerning the individual cloud resources (e.g., cloud resources 56, 58, 60) available/provided, wherein metadata 62, 64, 66 may define the cloud resources 56, 58, 60 (respectively) offered by cloud service providers 50, 52, 54 (respectively). Accordingly, user 34 (via laptop computer 28) may access data management process 10. As discussed above, data management process 10 as used in this disclosure may include any combination of data management process 10s, client-side process 10c1, client-side process 10c2 and client-side process 10c3.

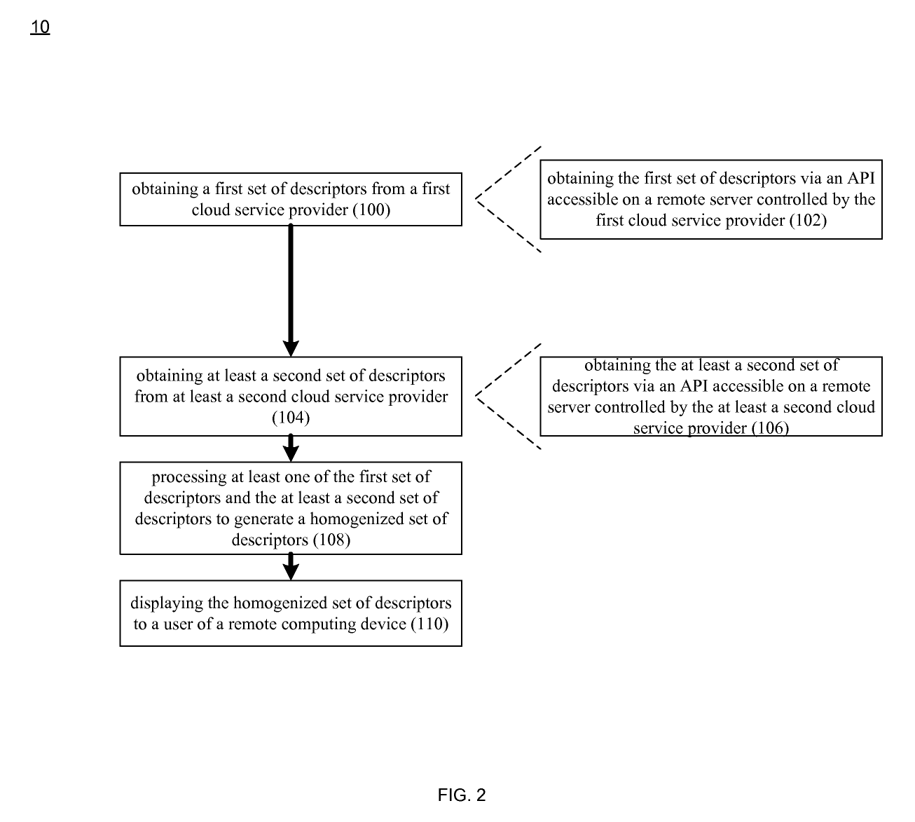

Referring also to FIG. 2, data management process 10 may obtain 100 a first set of descriptors (e.g., metadata 62) from a first cloud service provider (e.g., cloud service provider 50). The first set of descriptors (e.g., metadata 62) may define one or more resources available from first cloud service provider 50. When obtaining 100 the first set of descriptors (e.g., metadata 62) from the first cloud service provider (e.g., cloud service provider 50), data management process 10 may obtain 102 the first set of descriptors (e.g., metadata 62) via an API (not shown) that is accessible on a remote server (e.g., server computer 68) that is controlled by the first cloud service provider (e.g., cloud service provider 50).

Data management process 10 may also obtain 104 at least a second set of descriptors from additional cloud service provider. These additional descriptor sets may define one or more resources available from additional cloud service providers. As with the metadata discussed above, these additional descriptor sets may include sets of metadata. When obtaining 104 these additional descriptor sets from additional cloud service providers, data management process 10 may obtain 106 additional descriptor sets via APIs (not shown) accessible on remote servers controlled by the additional cloud service providers.

Continuing with the above-stated example, data management process 10 may obtain 104 a second set of descriptors (e.g., metadata 64) from another cloud service provider (e.g., cloud service provider 52). The second set of descriptors (e.g., metadata 64) may define one or more resources available from cloud service provider 52. When obtaining 104 the second set of descriptors (e.g., metadata 64) from another cloud service provider (e.g., cloud service provider 52), data management process 10 may obtain 106 the second set of descriptors (e.g., metadata 64) via an API (not shown) that is accessible on a remote server (e.g., server computer 70) that is controlled by cloud service provider 52.

Further, data management process 10 may obtain 104 a third set of descriptors (e.g., metadata 66) from another cloud service provider (e.g., cloud service provider 54). The third set of descriptors (e.g., metadata 66) may define one or more resources available from cloud service provider 54. When obtaining 104 the third set of descriptors (e.g., metadata 66) from another cloud service provider (e.g., cloud service provider 54), data management process 10 may obtain 106 the third set of descriptors (e.g., metadata 66) via an API (not shown) that is accessible on a remote server (e.g., server computer 78) that is controlled by cloud service provider 54.

While the above example defines three cloud service providers, this is for illustrative purposes only and is not intended to be a limitation of this disclosure, as other configurations are possible. For example, the quantity of cloud service providers may be increased or decreased depending upon the quantity of cloud service provided accessible by data management process 10.

Data management process 10 may process 108 these sets of descriptors (e.g., the first set of descriptors (e.g., metadata 62), the second set of descriptors (e.g., metadata 64), and the third set of descriptors (e.g., metadata 66)) to generate a homogenized set of descriptors (e.g., homogenized metadata 74). The homogenized set of descriptors (e.g., homogenized metadata 74) may describe the one or more resources available from these cloud service provider (e.g., cloud service providers 50, 52, 54) in a uniform fashion.

For example, assume that the resources that user 34 was interested in concern “computing resources”. Unfortunately, the first set of descriptors (e.g., metadata 62) obtained from the first cloud service provider (e.g., cloud service provider 50) may describe these resources as “instances”, while the second set of descriptors (e.g., metadata 64) obtained from the second cloud service provider (e.g., cloud service provider 52) may describe these resources as “EC2”, while the third set of descriptors (e.g., metadata 66) obtained from the third cloud service provider (e.g., cloud service provider 54) may describe these resources as “virtual machines”. Accordingly, the disparity in nomenclature for the same cloud resource may make it difficult/impossible for user 34 to make any meaningful comparison of available cloud resources and/or administer these cloud resources.

Accordingly, data management process 10 may process 108 these sets of descriptors (e.g., the first set of descriptors (e.g., metadata 62), the second set of descriptors (e.g., metadata 64), and the third set of descriptors (e.g., metadata 66)) to generate a homogenized set of descriptors (e.g., homogenized metadata 74), wherein this common type of resources available from all three cloud service provides (e.g., cloud service providers 50, 52. 54) may uniformly be referred to as “computing resources”.

When processing 108 these sets of descriptors (e.g., metadata 62, 64, 66) to generate the homogenized set of descriptors (e.g., homogenized metadata 74), data management process 10 may generate the homogenized set of descriptors (e.g., homogenized metadata 74) by processing 108 one of more of the sets of descriptors (e.g., metadata 62, metadata 64) to be compatible with one of the other sets of descriptors (e.g., metadata 66). Accordingly, the nomenclature of the first set of descriptors may be processed 108 to make it match the nomenclature of the other set(s) of descriptors, thus generating the homogenized set of descriptors (e.g., homogenized metadata 74).

Alternatively, when processing 108 these sets of descriptors (e.g., metadata 62, 64, 66) to generate the homogenized set of descriptors (e.g., homogenized metadata 74), data management process 10 may generate the homogenized set of descriptors (e.g., homogenized metadata 74) by processing 108 all of the sets of descriptors (e.g., metadata 62, 64, 66) to generate the homogenized set of descriptors (e.g., homogenized metadata 74) that has a unique nomenclature (e.g., different than that used by any of cloud service providers 50, 52. 54).

When processing 108 these sets of descriptors (e.g., metadata 62, 64, 66), data management process 10 may access one or more databases (e.g., included within storage device 16) that correlates the cloud resources available on one cloud service provider with the cloud resources available on another cloud services provider. For example, one cloud service provider may use “security group” for the term firewall, while another may use VPC (i.e., Virtual Private Cloud). Further, some cloud resources may be available from one cloud service provider, while not available from another. For example, tagging may be available from one cloud service provider but not available from another cloud service provider. Database cloud resources may be RDS from one cloud service provider, may be SQL from another cloud service provider, and may be OpenStack from a third cloud service provider.

Once the homogenized set of descriptors (e.g., homogenized metadata 74) are generated by data management process 10, data management process 10 may display 110 the homogenized set of descriptors (e.g., homogenized metadata 74) for user 34 on a remote computing device (e.g., laptop computer 38). Through the use of such homogenized set of descriptors (e.g., homogenized metadata 74) generated by data management process 10, user 34 may more easily compare the offerings of different cloud service providers (e.g., cloud service providers 50, 52. 54) and administer the resources that user 34 purchases from the cloud service providers (e.g., cloud service providers 50, 52. 54).

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data management processing apparatus, such that the instructions, which execute via the processor of the computer or other programmable data management processing apparatus, create means for implementing the functions/acts specified in the flowchart and/or block diagram block or blocks.

These computer program instructions may also be stored in a computer-readable memory that may direct a computer or other programmable data management processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data management processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implement method comprising:
obtaining a first set of descriptors from a first cloud service provider, wherein the first set of descriptors defines one or more resources available from the first cloud service provider;
obtaining at least a second set of descriptors from at least a second cloud service provider, wherein the at least a second set of descriptors defines one or more resources available from the at least a second cloud service provider; and
processing at least one of the first set of descriptors and the at least a second set of descriptors to generate a homogenized set of descriptors, wherein the homogenized set of descriptors describes the one or more resources available from the first cloud service provider and the one or more resources available from the at least a second cloud service provider in a uniform fashion.

2. The computer-implemented method of claim 1 further comprising:
displaying the homogenized set of descriptors to a user of a remote computing device.

3. The computer-implemented method of claim 1 wherein:
the first set of descriptors includes a first set of metadata; and
the at least a second set of descriptors includes at least a second set of metadata.

4. The computer-implemented method of claim 1 wherein obtaining the first set of descriptors from the first cloud service provider includes:
obtaining the first set of descriptors via an API accessible on a remote server controlled by the first cloud service provider.

5. The computer-implemented method of claim 1 wherein obtaining at least a second set of descriptors from at least a second cloud service provider includes:
obtaining the at least a second set of descriptors via an API accessible on a remote server controlled by the at least a second cloud service provider.

6. The computer-implemented method of claim 1 wherein processing at least one of the first set of descriptors and the at least a second set of descriptors to generate a homogenized set of descriptors includes:
generating the homogenized set of descriptors by processing the first set of descriptors to be compatible with the at least a second set of descriptors.

7. The computer-implemented method of claim 1 wherein processing at least one of the first set of descriptors and the at least a second set of descriptors to generate a homogenized set of descriptors includes:
generating the homogenized set of descriptors by processing the at least a second set of descriptors to be compatible with the first set of descriptors.

8. The computer-implemented method of claim 1 wherein processing at least one of the first set of descriptors and the at least a second set of descriptors to generate a homogenized set of descriptors includes:
generating the homogenized set of descriptors by processing the first set of descriptors and the at least a second set of descriptors.

9. A computer program product residing on a computer readable medium having a plurality of instructions stored thereon which, when executed by a processor, cause the processor to perform operations comprising:
obtaining a first set of descriptors from a first cloud service provider, wherein the first set of descriptors defines one or more resources available from the first cloud service provider;
obtaining at least a second set of descriptors from at least a second cloud service provider, wherein the at least a second set of descriptors defines one or more resources available from the at least a second cloud service provider; and
processing at least one of the first set of descriptors and the at least a second set of descriptors to generate a homogenized set of descriptors, wherein the homogenized set of descriptors describes the one or more resources available from the first cloud service provider and the one or more resources available from the at least a second cloud service provider in a uniform fashion.

10. The computer program product of claim 9 further comprising instructions for:
displaying the homogenized set of descriptors to a user of a remote computing device.

11. The computer program product of claim 9 wherein:
the first set of descriptors includes a first set of metadata; and
the at least a second set of descriptors includes at least a second set of metadata.

12. The computer program product of claim 9 wherein the instructions for obtaining the first set of descriptors from the first cloud service provider include instructions for:
obtaining the first set of descriptors via an API accessible on a remote server controlled by the first cloud service provider.

13. The computer program product of claim 9 wherein the instructions for obtaining at least a second set of descriptors from at least a second cloud service provider include instructions for:
obtaining the at least a second set of descriptors via an API accessible on a remote server controlled by the at least a second cloud service provider.

14. The computer program product of claim 9 wherein the instructions for processing at least one of the first set of descriptors and the at least a second set of descriptors to generate a homogenized set of descriptors include instructions for:
generating the homogenized set of descriptors by processing the first set of descriptors to be compatible with the at least a second set of descriptors.

15. The computer program product of claim 9 wherein the instructions for processing at least one of the first set of descriptors and the at least a second set of descriptors to generate a homogenized set of descriptors include instructions for:
generating the homogenized set of descriptors by processing the at least a second set of descriptors to be compatible with the first set of descriptors.

16. The computer program product of claim 9 wherein the instructions for processing at least one of the first set of descriptors and the at least a second set of descriptors to generate a homogenized set of descriptors include instructions for:
generating the homogenized set of descriptors by processing the first set of descriptors and the at least a second set of descriptors.

17. A computing system including a processor and memory configured to perform operations comprising:
obtaining a first set of descriptors from a first cloud service provider, wherein the first set of descriptors defines one or more resources available from the first cloud service provider;
obtaining at least a second set of descriptors from at least a second cloud service provider, wherein the at least a second set of descriptors defines one or more resources available from the at least a second cloud service provider; and
processing at least one of the first set of descriptors and the at least a second set of descriptors to generate a homogenized set of descriptors, wherein the homogenized set of descriptors describes the one or more resources available from the first cloud service provider and the one or more resources available from the at least a second cloud service provider in a uniform fashion.

18. The computing system of claim 17 further configured to perform operations comprising:
displaying the homogenized set of descriptors to a user of a remote computing device.

19. The computing system of claim 17 wherein:
the first set of descriptors includes a first set of metadata; and
the at least a second set of descriptors includes at least a second set of metadata.

20. The computing system of claim 17 wherein obtaining the first set of descriptors from the first cloud service provider includes:
obtaining the first set of descriptors via an API accessible on a remote server controlled by the first cloud service provider.

21. The computing system of claim 17 wherein obtaining at least a second set of descriptors from at least a second cloud service provider includes:
obtaining the at least a second set of descriptors via an API accessible on a remote server controlled by the at least a second cloud service provider.

22. The computing system of claim 17 wherein processing at least one of the first set of descriptors and the at least a second set of descriptors to generate a homogenized set of descriptors includes:
generating the homogenized set of descriptors by processing the first set of descriptors to be compatible with the at least a second set of descriptors.

23. The computing system of claim 17 wherein processing at least one of the first set of descriptors and the at least a second set of descriptors to generate a homogenized set of descriptors includes:
generating the homogenized set of descriptors by processing the at least a second set of descriptors to be compatible with the first set of descriptors.

24. The computing system of claim 17 wherein processing at least one of the first set of descriptors and the at least a second set of descriptors to generate a homogenized set of descriptors includes:
generating the homogenized set of descriptors by processing the first set of descriptors and the at least a second set of descriptors.
